(19) United States
(12) Patent Application Publication
(10) Pub. No.: US 2008/0059245 A1
(43) Pub. Date: Mar. 6, 2008

(54) MEDICAL IMAGE MANAGEMENT METHOD, MEDICAL IMAGE MANAGEMENT APPARATUS, AND MEDICAL NETWORK SYSTEM

(75) Inventors: Hideyuki SAKAIDA, Tokyo (JP); Yoshihiro Ito, Ashigarakami-gun (JP); Naoki Mochizuki, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/846,844

(22) Filed: Aug. 29, 2007

(30) Foreign Application Priority Data
Aug. 30, 2006 (JP) 2006-234131

(51) Int. Cl. G06Q 50/00

(52) U.S. Cl. 705/3

(57) ABSTRACT

An image server stores volume data including a plurality of tomographic images. A doctor sends transfer request of volume data through a client terminal to the image server when reading an image. Upon receiving the transfer request, a CPU of the image server refers to a doctor information DB based on a doctor ID included in the transfer request to judge a site allowed to be browsed by the doctor who has requested. Upon judging the site allowed to be browsed, the CPU refers to site information preliminarily recorded on each tomographic image of the requested volume data. Thereafter, it is determined whether the doctor who has requested is allowed to browse each of the tomographic images or not based on the site information and the site allowed to be browsed. After judging, the CPU transfers only tomographic images allowed to be browsed to the client terminal as the requester.

### FIELD OF THE INVENTION

The present invention relates to a medical image management method for storing a plurality of medical images obtained in one examination in a storage device and reading out each of the medical images from the storage device in response to a request from a user, and a medical image management apparatus and a medical network system using the same.

### BACKGROUND OF THE INVENTION

Various modalities such as a computed radiography (CR) device, a computed tomography (CT) device, a magnetic resonance imaging (MRI) device, a positron emission tomography (PET) device, and a ultrasonic device are in widespread use in medical facilities such as clinics and hospitals. A medical image captured by use of the modality is used when a doctor examines a patient, and takes an important part in determining disease state of the patient.

The medical images are stored in the medical facilities for a long period of time for the purpose of confirming prognosis. Accordingly, a large amount of medical images must be stored in the medical facilities, and when each of the medical images in a form of film or the like is to be stored, large burdens of ensuring of storage space, management operation, searching operation, and the like are caused. In order to avoid the burdens, a system in which captured images are digitized and stored in a server or the like is disclosed in Japanese Patent Translation Publication No. 2005-523758, for example. Since only space for a server is required, such a system can save storage space for medical images drastically in medical facilities. Additionally, since management operation and searching operation are performed by the server, it is possible to achieve efficiency in services in the medical facilities.

The CT device, MRI device, or the like for capturing tomographic images as the medical images generally obtains a plurality of medical images of different sites in one examination. Further, recently, improvement in capturing ability of each modality has been made, and a wide-range site such as an entire body of a patient is becoming a photographic subject.

A huge number of medical images captured through such wide range photography are not always read by one doctor, but by several doctors specialized for each of the sites. For example, when the tomographic images of a part extending from a cephalic region to an abdominal region is captured, the image reading for each site is performed by different doctors, that is, the cephalic region is read by a doctor of a cranial nerve department, a chest region is read by a doctor of a respiratory department, and an abdominal region is read by a doctor of a cardiovascular department.

The medical images obtained in one examination are stored as a group in a server. Therefore, a doctor of each department must search for the medical image of the site of his or her specialty from the medical images of one examination stored in the server before performing the image reading. The searching operation takes a lot of time, and this becomes a problem.

Moreover, in a case where the doctor of each department can browse all of the medical images of one examination, the doctor may read image of the site out of his/her specialty by mistake. Naturally, the doctor has less skill for the site out of his/her specialty compared with for the site of his/her specialty, and therefore image reading of the site out of his/her specialty may cause wrong diagnosis such as oversight of disease or the like. Therefore, in a case where a plurality of medical images are obtained in one examination, it is desired that the doctor of each department observes only the medical image of the site of his/her specialty.

As related prior arts, there is disclosed a technique of recognizing a site captured in a medical image and selecting a displaying method suitable for the site in Japanese Patent Translation Publication No. 2005-523758. However, in the technique disclosed therein, only recognition of the site of each medical image is performed, and no consideration is given to processing of a plurality of medical images and processing in accordance with each user.

Further, in Japanese Patent Laid-Open Publication No. 2002-329003, there is disclosed a technique in which a position of a user (such as a doctor and nurse) is judged, examination items suitable for the position of the user are selected from a plurality of examination items such as a blood test and a urinalysis, and only the selected examination items are displayed. However, since a plurality of medical images captured by use of the CT device or the MRI device are obtained all together in one examination, the technique disclosed therein is not sufficient to select only the medical image of the site of his/her specialty among the medical images.

### SUMMARY OF THE INVENTION

In view of the above, an object of the present invention is to provide a medical image management method, a medical image management apparatus, and a medical network system for allowing each user to browse only a medical image of a necessary site among a plurality of medical images obtained in one examination.

In order to achieve the above problem, according to the present invention, there is provided a medical image management method for storing a plurality of medical images obtained in one examination in a storage device and reading out each of the medical images from the storage device in accordance with a request from a user. The medical image management method is characterized by including: a first judging step of judging an anatomic site to be browsed by the user based on user information for identifying the user; and a second judging step of judging whether each of the medical images is allowed to be browsed by the user or not based on site information representing the anatomic site of each of the medical images and a result of judgment in the first judging step.

Note that the user information preferably includes information of a diagnosis and treatment department related to the user. Preferably, in the first judging step, the diagnosis and treatment department related to the user is confirmed based on the user information, and an anatomic site in which his/her diagnosis and treatment department specialized is judged as an anatomic site allowed to be browsed by the user.

Further, in the second judging step, it is preferable that judgment is performed such that the medical image whose anatomic site represented by the site information corresponds to the anatomic site judged in the first judging step is allowed to be browsed and the medical image whose anatomic site represented by the site information does not correspond to the anatomic site judged in the first judging step is not allowed to be browsed.

Furthermore, the medical image management method according to the present invention is preferably includes: a recognizing step of recognizing an anatomic site captured in each of the medical images; and a site information generating step of generating the site information based on a result of recognition of the recognizing step. In the site information generating step it is preferable to generate the site information as metadata of each of the medical images.

Note that the medical image management method according to the present invention may further includes: a reading step of reading out the medical image allowed to be browsed in the second judging step from the storage device; and a transferring step of transferring the medical image read out by the reading step to the user.

Further, the anatomic site preferably includes a cephalic region, a chest region, an abdominal region, a pelvic region, a leg region, and organs such as a brain, a heart, a lung, a liver, and a stomach.

Furthermore, the medical images are assembled all together as an image group for each examination and stored in the storage device.

Note that a medical image management apparatus according to the present invention includes a storage device for storing a plurality of medical images obtained in one examination and a read-out control device for reading out each of the medical images from the storage device in accordance with a request from a user. The medical image management apparatus is characterized by including: a first judging device for judging an anatomic site allowed to be browsed by the user based on user information for identifying the user; and a second judging device for judging whether each of the medical images is to be browsed by the user or not based on site information representing the anatomic site captured in each of the medical images and a result of judgment in the first judging device.

Further, a medical network system according to the present invention includes a server having a storage device for storing a plurality of medical images obtained in one examination and a terminal connected to the server through a network to read out each of the medical images from the sever in accordance with a request from a user. The medical network system includes: a first judging device for judging an anatomic site to be browsed by the user based on user information for identifying the user; a second judging device by judging whether each of the medical images is allowed to be browsed by the user or not based on site information representing the anatomic site captured in each of the medical images and a result of judgment in the first judging device; and a transferring device for transferring the medical image allowed to be browsed in the second judging device to the terminal. The first judging device, the second judging device, and the transferring device are provided in the server.

According to the present invention, an anatomic site allowed to be browsed by the user is judged based on user information for identifying the user, and whether each of the medical images is allowed to be browsed by the user or not is judged based on a result of the judgment and site information representing the anatomic site captured in each of the medical images. Thereby, each user can readily browse only medical images of a necessary anatomic site among a plurality of the medical images by browsing the medical images allowed to be browsed. Therefore, it is possible to save the trouble of having to search the medical image of the anatomic site necessary for each user among a plurality of medical images. Further, it is also possible to prevent that the doctor or the like conducts diagnosis for an anatomic site out of his/her hands by mistake.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is a block diagram schematically showing a structure of a medical network system according to the present invention;

FIG. 2 is an explanatory view schematically showing a structure including volume data and each tomographic image;

FIG. 3 is a block diagram schematically showing a structure of an image server;

FIG. 4 is an explanatory view schematically showing a structure of a doctor information a database; and

FIG. 5 is a flow chart schematically showing an operation of the medical network system.

### DESCRIPTION OF THE PREFERRED EMBODIMENTS

A preferred embodiment of the present invention is described hereinbelow. The present invention, however, is not limited to this.

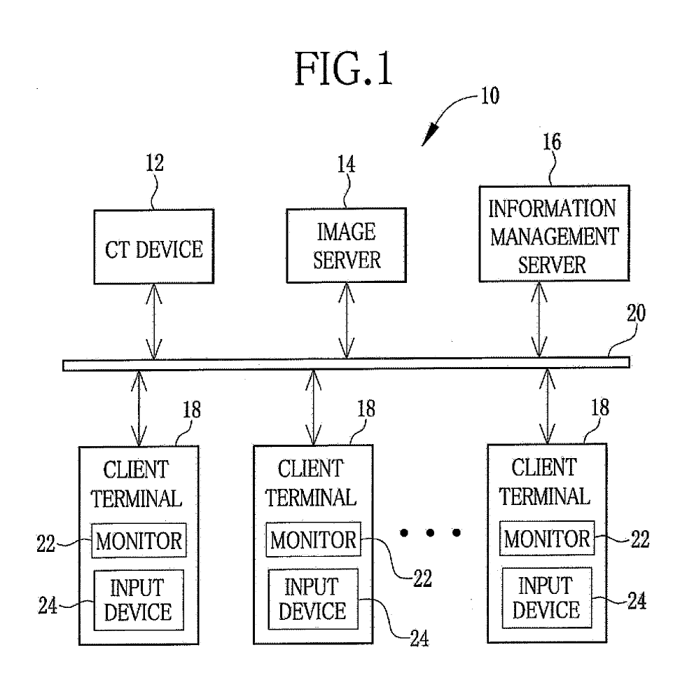

A medical network system 10 shown in FIG. 1 is used in a medical facility such as a hospital, and includes a CT device 12 for capturing a tomographic image or the like of a patient as a medical image, an image server 14 (a medical image management apparatus or server) for storing various medical images such as the tomographic images captured by the CT device 12, an information management server 16 for managing various kinds of information in the medical facility, and a plurality of client terminals (referred to as terminals) 18 used by doctors for diagnosis or the like. These components are connected to one another through a local area network (LAN, referred to as network) 20 in the medical facility.

The medical network system 10 reduces the storage space for medical charts, the films of medical images, and the like from the medical facility by managing various kinds of information, the medical images, and the like generated in the medical facility in a form of electronic data. Additionally, the medical network system 10 allows each of the client terminals 18 to read out various kinds of information, medical images, and the like readily, thus achieving efficiency of operation in the medical facility. Note that, although FIG. 1 shows the plurality of client terminals 18, the medical network system 10 may include only one client terminal 18. On the contrary, the medical network system 10 may include a plurality of CT devices 12, image servers 14, and information management servers 16.

The image server 14 is a PACS (picture archiving and communication system for medical application) server, for example. The image server 14 stores not only the tomographic images obtained by the CT device 12 but also the medical images transferred from other medical facilities through network, media, or the like, and reference images for comparison of disease states, for example. The respective medical images stored in the image server 14 are read out by the respective client terminals 18 according to need, and used by the doctors for image reading, explanation for a patient, and the like. Note that the medical images include not only the tomographic images captured by the CT device 12 but also images captured by other modalities such as a CR device and a MRI device. Additionally, the reference images include illustrations and the like other than the images captured by the modalities.

The information management server 16 is a HIS (hospital information system) server, or a RIS (radiology information system) server, for example. The information management server 16 manages various kinds of information including patient information, diagnosis information, examination information, account information, and the like for each patient. Note that the patient information is a personal information of each patient, and includes a full name, a patient ID, a present address, date of birth, age, sex, family structure, past history, presence or absence of allergy, and the like, for example.

The diagnosis information is information about diagnosis for a patient, and includes a date of examination, a diagnosis and treatment department, a disease name, a diagnostic outcome, a diagnostic period, kind and quantity of medicine, a dispensing pharmacy, and the like, for example. Note that the diagnostic period means a period for which the patent goes to hospital for medical attendance of the same disease. The examination information is information about the medical images captured in the diagnosis, and includes an examination date, an examination device, an examination method, an examined site, and the like, for example. Note that the examination method means a direction (such as the front or the side) of the patient in capturing a medical image, and a state with or without a barium meal, for example. The examined site is a target for examination such as a cephalic region, a chest region, an abdominal region, a pelvic region, a leg region, and a head and neck region and a thoracoabdominal region including some of the above regions, and the like. The account information includes a medical expense, a dosage cost, an examination cost, and information representing a state with or without insurance application, and the like, for example.

Each of the plurality of client terminals 18 is disposed in each examination room or each diagnosis and treatment department in the medical facility, for example. Each of the client terminals 18 is a common personal computer or work station, for example, and provided with a monitor 22 for displaying various kinds of information and medical images, an input device 24 for inputting the various kinds of information, and the like. While conducting diagnosis face to face with the patient, the doctor displays the tomographic image captured by the CT device 12, various kinds of information read out from the information management server 16, and the like on the monitor 22, and explains the diagnostic outcome and the like. Further, the doctor inputs various kinds of information obtained by conducting the diagnosis and the like by use of the input device 24. Note that the input device 24 may be a common input device such as a key-board and a mouse.

Moreover, the information management server 16 includes an appointment list of the CT device 12. When it is necessary to capture an image by use of the CT device 12, the doctor accesses the appointment list in the information management server 16 through the client terminal 18. Then, the doctor designates a vacant day in the appointment list, and inputs order information including content of examination therein. Accordingly, an appointment of examination by use of the CT device 12 is completed. Upon receiving new appointment of examination, or at a predetermined interval, the information management server 16 delivers the order information to the client terminal 18 in the radiology department and the CT device 12. The doctor, technologist, or the like in the radiology department operates the CT device 12 based on the order information to capture the tomographic image corresponding to the order information.

As described above, the information management server 16 manages the information about each patient and available state of the CT device 12, to prevent a situation in which a plurality of appointments for the same period of time are scheduled. Note that the order information includes the examination method, the examined site, the ID number of a patient to be examined, the ID number of the doctor having requested the examination, and the like.

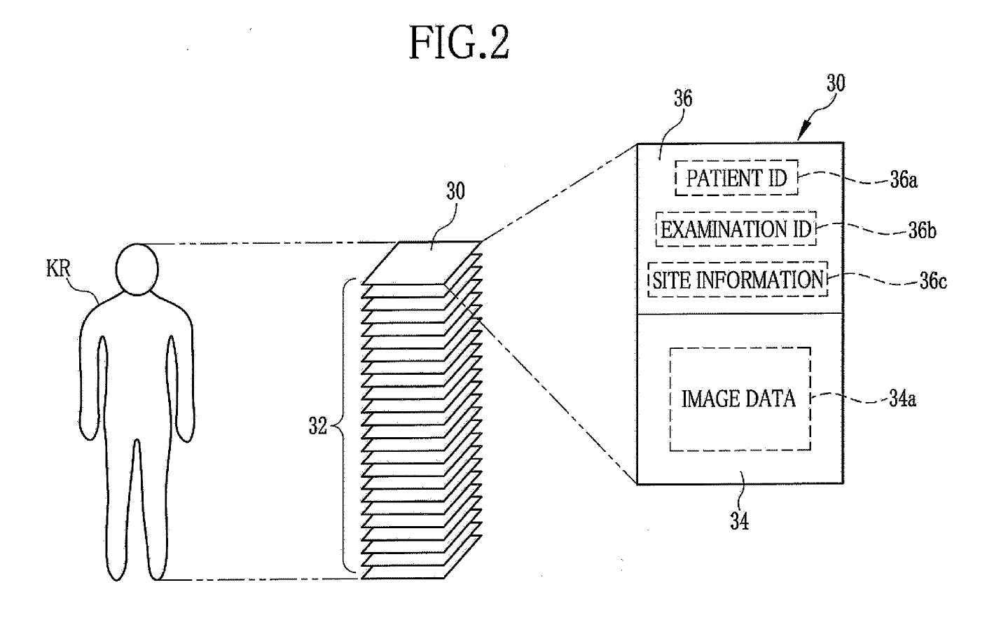

The image of patient KR is captured based on the order information by use of the CT device 12. As shown in FIG. 2, a plurality of the tomographic images 30 corresponding to setting of slice thickness or the like are obtained in one examination. The obtained tomographic images 30 are transferred to the image server 14 and assembled all together for each examination to be stored therein. Note that hereinbelow an assembly of the tomographic images 30 obtained in one examination is referred to as volume data (image group) 32.

As shown in FIG. 2, each of the tomographic images 30 includes an image recording area 34 for recording image data 34a and a tag area 36 for recording metadata. For example, various kinds of information such as a patient ID 36a, an examination ID 36b, and site information 36c is recorded as metadata in the tag area 36 of the tomographic image 30. The patient ID 36a is used for identifying to which patient KR the tomographic image 30 belongs. The examination ID 36b is an inherent number allocated to each examination, for example. The examination ID 36b makes it possible to identify in which examination the tomographic image 30 was captured, and is used for managing each of the tomographic images 30 as the volume data 32.

The site information 36c represents which site is captured on the tomographic image 30. The metadata are recorded at the same time of generating the image data 34a when the tomographic image 30 is captured. Alternatively, the metadata is recorded in the image server 14 or the client terminal 18 after the tomographic image 30 is captured. Note that the metadata recorded in the tag area 36 is not limited to the above, and may be any kind of information as long as it can serve to identify the tomographic images 30. Additionally, a file format for the medical image with the tag area 36 described above is a DICOM (format), for example.

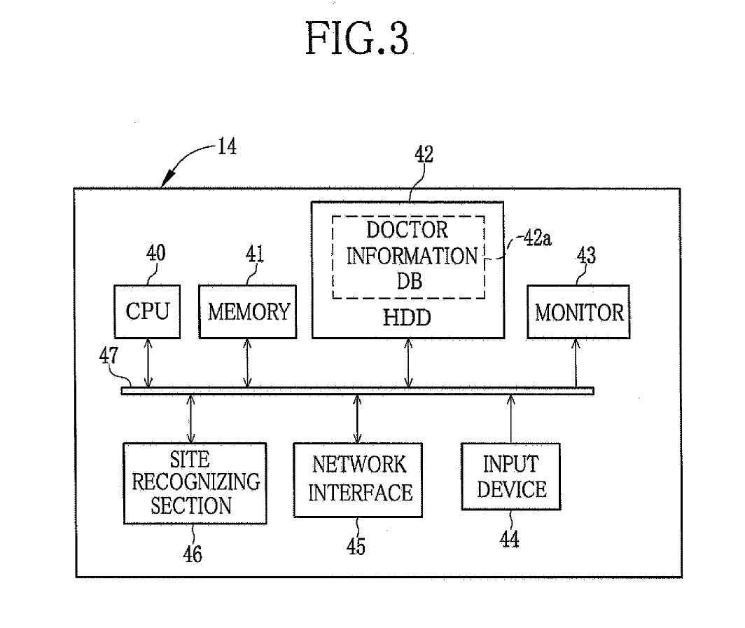

As shown in FIG. 3, the image server 14 is a common personal computer or a work station, and includes CPU (a read-out control device, a first judging device, and a second judging device) 40, a memory 41, a HDD (storage device) 42, a monitor 43, an input device 44, a network interface (transferring device) 45, and a site recognizing section 46. The respective components are connected to one another via a bus 47.

Various programs corresponding to the medical network system 10, various medical images such as the tomographic image 30 obtained by the CT device 12, and the like are stored in the HDD 42. The CPU 40 reads out the respective programs from the HDD 42 to the memory 41, and sequentially manipulates the programs thus read out, to control the image server 14 as a whole. Upon receiving the medical image through the network interface 45, the CPU 40 stores the medical image in a predetermined area of the HDD 42. Then, the CPU 40 reads out the stored medical image from the HDD 42 in accordance with a request from each of the client terminals 18, and transfers the image thus read out to the client terminal 18 as a requester.

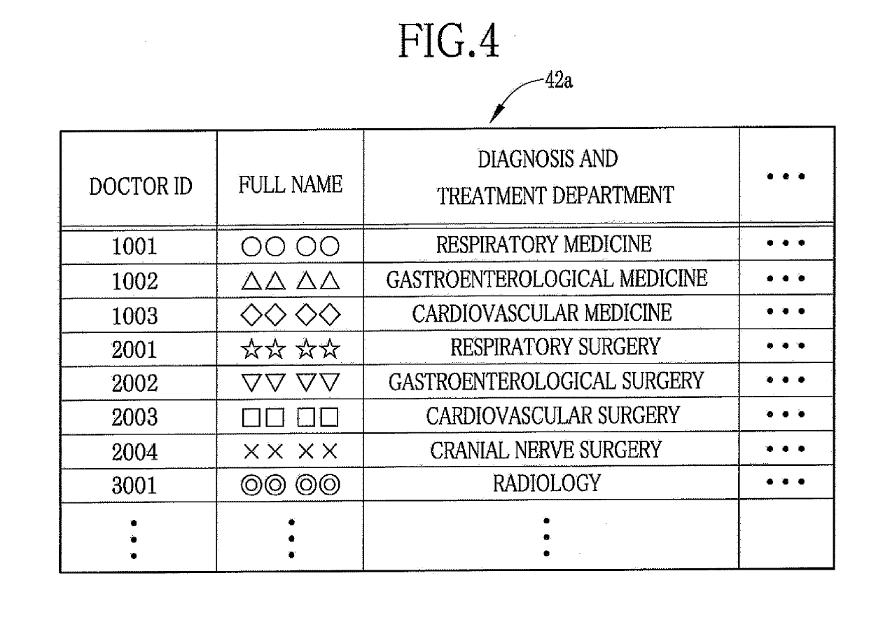

Moreover, the HDD 42 includes a doctor information data base (DB) 42a having information about each doctor (corresponding to user information described in claims) who works for the medical facility. For example, as shown in FIG. 4, various kinds of information such as a doctor ID allocated to each doctor, full name of the doctor, diagnosis and treatment department to which the doctor belongs, and the like are related to one another and recorded in the doctor information DB 42a. The doctor information DB 42a is used to confirm the doctor who has requested transfer of medical image, for example.

Note that, although the various programs, the medical images, and the like are stored in the same HDD 42 in this embodiment, they may be stored in different HDDs. Further, although the medical images and the like are stored in a so-called built-in HDD in this embodiment, the present invention is not limited to the above embodiment, and the medical images and the like may be stored in an external HDD, or various media such as DVD-ROM and CD-ROM, for example.

The monitor 43 displays various operation screens in accordance with the processes of the program executed by the CPU 40. Note that the monitor 43 may be a common display device such as a liquid crystal display or a CRT display. The input device 44 includes a keyboard, a mouse, and the like, for example. An administrator in the medical facility uses the monitor 43 and the input device 44 to update the programs recorded in the HDD 42 and check the medical images stored in the HDD 42, for example. The network interface 45 connects the image server 14 to the LAN 20 in the medical facility. The network interface 45 is selected in accordance with a standard of the LAN 20 such as Ethernet (trademark).

The site recognizing section 46 performs image analysis for the input tomographic image 30 to recognize which site is captured in the image. Further, the site recognizing section 46 records the recognized site as the site information 36c in the tag area 36 of the tomographic image 30. Note that the image analysis by the site recognizing section 46 is performed by calculating amount of characteristic of the image based on a CT value of each pixel and matching the calculated amount of characteristic with a preliminarily stored amount of characteristic of each site.

Recently, improvement in capturing ability of the CT device 12 and increase in memory capacity of the image server 14 has been promoted, and a wide-range area such as an entire body of a patient is captured in order to conduct diagnosis more correctly and avoid the trouble of having to perform capturing again. However, when the doctor performs image reading, all the tomographic images 30 of such a wide range area are not always necessary. In this case, the transfer waiting time for the doctor is increased by transfer of unnecessary tomographic images 30, and the doctor have an excess load in searching for the tomographic images 30 of the desired site among a plurality of the tomographic images 30.

In order to prevent the above problem, upon receiving the volume data 32 from the CT device 12, for example, the image server 14 inputs the volume data 32 into the site recognizing section 46 and directs the site recognizing section 46 to recognize the site captured in the tomographic images 30 in the volume data 32. Then, only the images of the site requested from the client terminal 18 are transferred to prevent the increase in waiting time for the doctor.

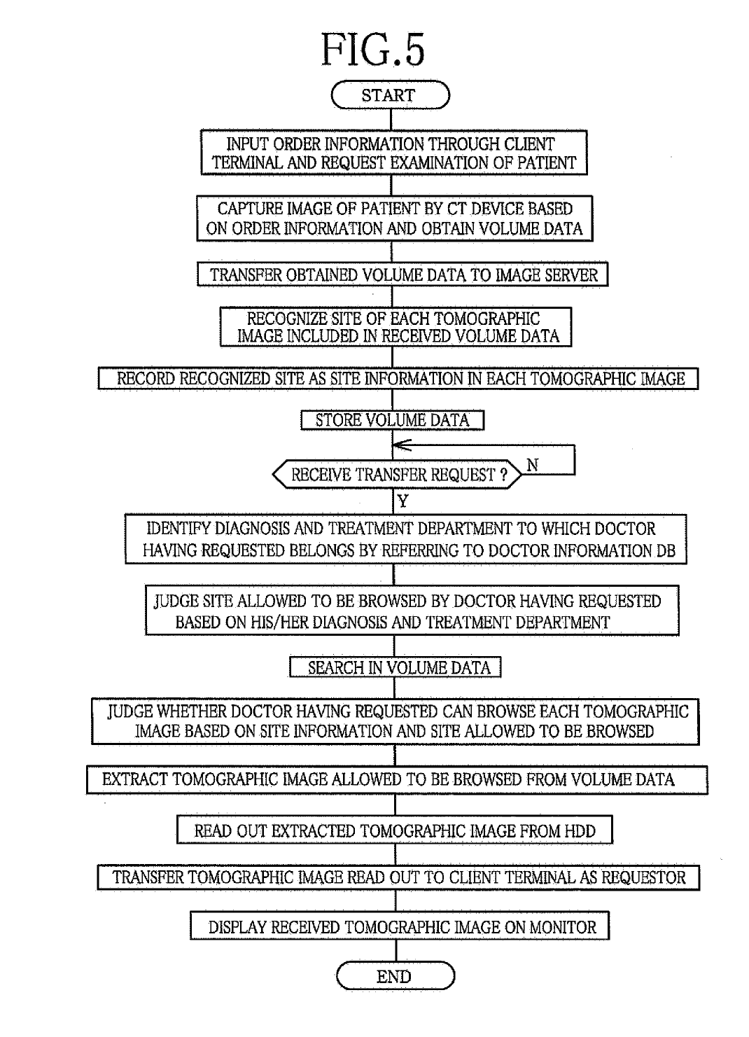

Next, by referring to a flowchart shown in FIG. 5, the operation of the medical network system 10 having the above configuration is explained. When determining that capturing by the CT device 12 is necessary for diagnosis, the doctor accesses the appointment list in the information management server 16 through the client terminal 18, and inputs the order information on a vacant day in the appointment list to make an appointment for examination by use of the CT device 12. The input order information is delivered to the CT device 12 and the client terminal 18 in the radiology department through the information management server 16.

An operator (a radiologist or a radiological technologist) of the CT device 12 confirms the order information on the client terminal 18, the CT device 12, or the like and captures the image of the patient KR based on the order information, to obtain the volume data 32 of the examined site designated by the order information. The CT device 12 records the patient ID 36a and the examination ID 36b in the tag area 36 of each tomographic image 30 included in the obtained volume data 32 based on the order information.

Note that regardless of the examined site designated by the order information, the entire body of the patient KR may be captured. The volume data 32 obtained by capturing the entire body necessarily includes the tomographic image 30 of the site that the doctor desires. Thereby, it is possible to prevent mismatch between the actually captured site and the examined site designated by the order information due to setting error of capturing range.

The obtained volume data 32 is transferred to the image server 14 via the LAN 20 or the like. Upon receiving the volume data 32, the CPU 40 of the image server 14 inputs the received volume data 32 into the site recognizing section 46, and directs the site recognizing section 46 to recognize the site of each tomographic image 30 included in the volume data 32. After recognizing the site of each tomographic image 30, the site recognizing section 46 records the recognized site in the tag area 36 of each tomographic image 30 to generate the site information 36c. After the site recognizing section 46 has recognized the site of each tomographic image 30, the CPU 40 stores the volume data 32 in the HDD 42. Thereby, the volume data 32 of the examination of each patient KR is stored in the HDD 42.

Next, when determining that the obtained volume data 32 is necessary for the image reading, the explanation for the patient, or the like, the doctor sends transfer request of the volume data 32 to the image server 14 through the client terminal 18. The transfer request includes various kinds of information such as the patient ID and the examination ID for specifying the volume data 32, the doctor ID of the doctor who has requested the transfer, and a terminal number of the client terminal 18 having sent the transfer request, for example. Note that the patient ID and the examination ID may be input directly by the doctor, or selected from a list of the volume data 32 stored in the image server 14. Additionally, the doctor ID may be input directly by the doctor, or may be identified from the account information when the doctors logs in the client terminal 18.

Upon receiving the transfer request, the CPU 40 of the image server 14 refers to the doctor information DB 42a of the HDD 42 based on the doctor ID included in the transfer request, and identifies the diagnosis and treatment department to which the doctor who has requested the transfer belongs. Upon identifying the diagnosis and treatment department of the doctor, the CPU 40 judges the site in which his/her department specializes as the site allowed to be browsed by the doctor who has requested (hereinafter referred to as site allowed to be browsed). For example, the CPU 40 judges a chest region as the site allowed to be browsed by a doctor belonging to a respiratory medicine, an abdominal region as the site allowed to be browsed by a doctor belonging to a gastroenterological medicine, and a cephalic region as the site allowed to be browsed by a doctor belonging to a cranial nerve medicine. Note that it is preferable to make a database which relates each diagnosis and treatment department to the site allowed to be browsed, and record the database on the HDD 42.

After judging the site allowed to be browsed by the doctor who has requested, the CPU 40 searches for the requested volume data 32 based on the patient ID 36a and the examination ID 36b included in the transfer request. After finding the volume data 32, the CPU 40 refers to the site information 36c of each tomographic image 30 contained in the volume data 32 and confirms whether the site recorded as the site information 36c corresponds to the site allowed to be browsed. Then, the CPU 40 judges whether the doctor who has requested should be allowed to browse the tomographic image 30 or not such that the tomographic images 30 of the corresponding site are allowed to be browsed and the tomographic images 30 of the in corresponding site are not allowed to be browsed.

Upon judging whether the respective tomographic images 30 are allowed to be browsed or not, the CPU 40 extracts the respective tomographic images 30 allowed to be browsed from the volume data 32, and reads out the extracted tomographic images 30 from the HDD 42. After reading out the respective tomographic images 30, the CPU 40 refers to the terminal number included in the transfer request, and transfers the extracted tomographic image 30 to the client terminal 18 as the requester.

Thereby, it is possible for the doctor who has sent the transfer request to browse only the tomographic images 30 of the necessary site in which his/her department specializes, among the requested volume data 32. Thus, it is also possible to save the trouble of searching in the volume data 32 to find the tomographic images 30 necessary for the doctor. Further, it is also possible to prevent that the doctor or the like reads the image out of his/her specialty by mistake. Furthermore, it is possible to suppress the wasteful transfer time due to the transfer of unnecessary tomographic images 30 and achieve decrease in waiting time for the doctor.

Upon receiving the tomographic image 30, the client terminal 18 displays the received tomographic image 30 on the monitor 22. In a case where the tomographic image 30 not allowed to be browsed is included in the volume data 32, it may be effective to inform the doctor or the like who has requested the volume data 32 by displaying the state on the monitor 22.

Note that, although the site recognition of each tomographic image 30 is performed at the time of receiving the volume data 32 from the CT device 12 in the above embodiment, the timing of performing the site recognition is not limited thereto. For example, the site recognition may be performed at the time of receiving the transfer request from the doctor. Further, although the site captured in each tomographic image 30 is automatically recognized by the image analysis in the above embodiment, the present invention is not limited thereto. The site recognition may be performed by checking with eyes of a doctor or the like. Further, when the recognition is performed by checking with eyes, the doctor or the like may record the site information 36c manually.

Moreover, although the site information 36c is recorded as the metadata on the tag area 36 in the tomographic image 30 in the above embodiment, the present invention is not limited thereto. For example, site information 36c of the respective tomographic images 30 may be recorded all together on a tabular file including the respective tomographic images 30 and the site related to each other. Further, although the anatomic site includes a cephalic region, a chest region, an abdominal region, a pelvic region, a leg region, and the like in the above embodiment, the present invention is not limited thereto. For example, the anatomic site may include organs such as a brain, a heart, a lung, a liver, and a stomach.

Note that although the user of the medical network system 10 is a doctor in the above embodiment, the user is not limited thereto. For example, the user may be a nurse and a technologist who belong to the medical facility, a patient who goes to the medical facility regularly, and the like.

Moreover, although the medical image is the tomographic image 30 captured by use of the CT device 12 in the above embodiment, the medical image is not limited thereto. For example, the medical image may be captured by use of any modality such as the MRI device and the PET device as long as it can capture a plurality of medical images in one examination.

Moreover, although the present invention is applied to the medical network system 10 used in one medical facility in the above embodiment, the present invention is not limited thereto. For example, the present invention may be applied to a medical network system including a plurality of medical facilities connected together. Further, although a medical image management device is the image server 14 in the above embodiment, the medical image management device is not limited thereto. For example, when the present invention is applied to the client terminal 18 to read out each tomographic image 30 from the HDD of the client terminal 18 and display the tomographic image 30 on the monitor 22, it is possible to judge whether the respective tomographic images 30 are allowed to be browsed or not.

The present invention is not to be limited to the above embodiments, and on the contrary, various modifications will be possible without departing from the scope and spirit of the present invention as specified in claims appended hereto.

What is claimed is:

1. A medical image management method for storing a plurality of medical images obtained in one examination in a storage device and reading out each of said medical images from said storage device in accordance with a request from a user, comprising:
a first judging step of judging an anatomic site allowed to be browsed by said user based on user information for identifying said user; and
a second judging step of judging whether each of said medical images is allowed to be browsed by said user or not based on site information representing an anatomic site of each of said medical images and a result of judgment in said first judging step.

2. A medical image management method as defined in claim 1, wherein said user information includes information of a diagnosis and treatment department related to said user, and
said first judging step includes:
identifying said diagnosis and treatment department related to said user based on said user information; and
judging an anatomic site in which said diagnosis and treatment department specializes as said anatomic site to be browsed by said user.

3. A medical image management method as defined in claim 2, wherein said second judging step includes judging such that said medical image whose anatomic site represented by said site information corresponds to said anatomic site judged in said first judging step is allowed to be browsed and said medical image whose anatomic site represented by said site information does not correspond to said anatomic site judged in said first judging step is not allowed to be browsed.

4. A medical image management method as defined in claim 3, further comprising:
a recognizing step of recognizing an anatomic site captured in each of said medical images; and
a site information generating step of generating said site information based on a result of recognition of said recognizing step.

5. A medical image management method as defined in claim 4, wherein said site information generating step includes generating said site information as metadata of each of said medical images.

6. A medical image management method as defined in claim 5, further comprising:
a reading step of reading out said medical image allowed to be browsed in said second judging step from said storage device; and
a transferring step of transferring said medical image read out by said reading step to a user.

7. A medical image management method as defined in claim 6, wherein said anatomic site includes a cephalic region, a chest region, an abdominal region, a pelvic region, a leg region, and organs such as a brain, a heart, a lung, a liver, and a stomach.

8. A medical image management method as defined in claim 7, wherein said medical images are assembled all together as an image group for each examination and stored in said storage device.

9. A medical image management apparatus including a storage device for storing a plurality of medical images obtained in one examination and a read-out control device for reading out each of said medical images from said storage device in accordance with a request from a user, comprising:
a first judging device for judging an anatomic site to be browsed by said user based on user information for identifying said user; and
a second judging device for judging whether each of said medical images is allowed to be browsed by said user or not based on site information representing an anatomic site captured in each of said medical images and a result of judgment in said first judging device.

10. A medical image management apparatus as defined in claim 9, wherein said user information includes information of a diagnosis and treatment department related to said user, and
said first judging device includes:
identifying said diagnosis and treatment department related to said user based on said user information; and
judging an anatomic site in which said diagnosis and treatment department specializes as said anatomic site allowed to be browsed by said user.

11. A medical image management apparatus as defined in claim 10, wherein said second judging device includes judging such that said medical image whose anatomic site represented by said site information corresponds to said anatomic site judged in said first judging device is allowed to be browsed and said medical image whose anatomic site represented by said site information does not correspond to said anatomic site judged in said first judging step is not allowed to be browsed.

12. A medical image management apparatus as defined in claim 11, further comprising:
a recognizing device of recognizing an anatomic site captured in each of said medical images; and
a site information generating device of generating said site information based on a result of recognition of said recognizing step.

13. A medical network system including a server having a storage device for storing a plurality of medical images obtained in one examination and a terminal connected to said server through a network to read out each of said medical images from said sever in accordance with a request from a user comprising:
a first judging device for judging an anatomic site allowed to be browsed by said user based on user information for identifying said user;
a second judging device for judging whether each of said medical images is allowed to be browsed by said user or not based on site information representing an anatomic site captured in each of said medical images and a result of judgment in said first judging device; and
a transferring device for transferring said medical image allowed to be browsed in said second judging device to said terminal, wherein
said first judging device, said second judging device, and said transferring device are provided in said server.
